(19) United States
(12) Patent Application Publication
(10) Pub. No.: US 2026/0214424 A1
(43) Pub. Date: Jul. 23, 2026

(54) MOBILE COMMUNICATION NETWORK FEATURING COORDINATED OPTIMIZATION

(71) Applicant: Telecom Italia S.p.A., Milano (IT)

(72) Inventors: Simone Bizzarri, Torino (IT); Francesco Mauro, Torino (IT); Maurizio Fodrini, Torino (IT); Paolo Goria, Pinerolo (IT)

(21) Appl. No.: 19/141,914

(22) PCT Filed: Nov. 29, 2023
(86) PCT No.: PCT/EP2023/083513

§ 371 Date: Jun. 20, 2025

(30) Foreign Application Priority Data
Dec. 21, 2022 (IT) 102022000026301

(51) Int. Cl. H04W 4/50; H04W 24/02; H04W 84/18

(52) U.S. Cl. CPC H04W 4/50; H04W 24/02; H04W 84/18

(57) ABSTRACT

A mobile communication network may include network nodes implementing functions for service provisioning to users; a self-organizing network (SON) module determining optimal configurations of the nodes; network resource controllers performing near-real-time control of access network resources used by the nodes for user requested service provisioning; a network resource model (NRM) management module managing configurations of the controllers; and an orchestration module communicably coupled to the SON and NRM management modules. Responsive to detecting an issue affecting the network, the orchestration module retrieves performance data; retrieves configuration data of at least one of the nodes, and/or of at least one of the controllers; and based on the performance and configuration data, and type of issue, type of service, type of users, configurations for the controllers, and/or self-organizing network algorithms, enable operation of the SON and/or NRM management modules to determine reconfiguration of the at least one node and/or controller.

### TECHNICAL FIELD

The present disclosure generally relates to the communication network field. More particularly, the present disclosure relates to a mobile communication network featuring autonomous coordinated optimization capabilities.

### OVERVIEW OF THE RELATED ART

A modern mobile communication network, such as a 4G or a 5G mobile communication network, is capable of implementing one or more autonomous optimizations or managements.

Considering, just as an example, a mobile communication network compliant with the Open Radio Access Network (O-RAN) architecture, for example the O-RAN architecture disclosed in “O-RAN Use Cases and Deployment Scenarios, Towards Open and Smart RAN” February 2020, both a management acting at network service level (for example, at Fault, Configuration, Accounting, Performance, and Security (FCAPS) level), hereinafter concisely referred to as FCAPS management, and a management acting at radio resource management (RRM) level, hereinafter concisely referred to also as RRM management, may be identified.

Concerning the FCAPS management, it may act both at the level of a single network function and at the level of a network portion (e.g., of the order of hundreds of network functions or network nodes), and in a manner (and, hence, with a timing) that is uncorrelated (or substantially uncorrelated) from service requests by users. FCAPS management typically determines long or relatively long intervention times (e.g., of the order of a few minutes up to a few hours), especially compared to a rate of the service requests from the users. Examples of FCAPS management include, but are not limited to, autonomous configuration and management of network nodes of the mobile communication network, for example by exploiting Self-Organizing Network (SON) functionalities. According to SON principles, parameter adjustments are performed which optimize the network performance: this enables the mobile communication network to carry a traffic it has been dimensioned for with high reliability and end-user Quality of Experience (QoE).

Concerning the RRM management, it acts based on (i.e., it is correlated with) the service requests from the users, and this affects both intervention types (which are aimed at, or involve, a reduced or relatively reduced set of network nodes or network functions) and intervention times (which are short or relatively short, e.g., of the order of fractions of a second up to a few seconds).

CN113923694 discloses a network resource arrangement method, a system, a device and a storage medium. The method comprises the following steps: receiving a user request message; the user request message carries user service parameter information; and integrally arranging network resources based on the current network situation and the user service parameter information, and sending a target request message to a target module. The access network orchestrator is set as an orchestrator for global adjustment and optimization of the access network resources and real-time measurement and control of the target user, information interaction with the network management system, the RAN intelligent control platform and the MEC host layer is carried out, the network resources are overall planned, and the network resources are managed and controlled in combination with the service quality and the service experience of the target user, so that real-time and non-real-time and overall and individual combined full-chain intelligent control of network resource arrangement is realized.

### SUMMARY

The Applicant has observed that none of the solutions known in the art is capable of performing optimizations or managements jointly at different levels in an efficient way.

According to the Applicant, this is essentially due to the fact that, considering just as an example the mobile communication network compliant with the O-RAN architecture (and, particularly, FCAPS management and RRM management), FCAPS management and RRM management are complementary to each other both in terms of intervention times and in terms of intervention types, and that separate and independent executions of the FCAPS management and of the RRM management may introduce dis-optimizations of one management with respect to the other, thus frustrating the efforts (of the FCAPS management) to obtain optimum network performance and/or optimum QoS, and the efforts (of the RRM management) to obtain optimum use of access network resources.

These issues are exacerbated in a modern mobile communication network, which features a working point dynamically affected by a strong variability over time of conditions including, but not limited to, the rate of the service requests from the users, user movements, and requested types of services.

Concerning CN113923694, the Applicant believes that the disclosed solution aimed at optimizing overall access network resources by ensuring service quality and service experience of target users, is not effective. Indeed, the Applicant believes that the solution disclosed in CN113923694, although being capable of addressing different scenarios (i.e., non-real-time network management level resources, near real-time network-level resources, and real-time user-level quality of service) based on user service parameter information and on network conditions, suffers from the limitation of considering only RRM management (and, hence, only a management based on service requests).

In view of the above, the Applicant has devised a system and a corresponding method capable of managing FCAPS management and RRM management in a coordinated manner.

One or more aspects of the present disclosure are set out in the independent claims, with advantageous features of the same disclosure that are indicated in the dependent claims, whose wording is enclosed herein verbatim by reference (with any advantageous feature being provided with reference to a specific aspect of the present disclosure that applies mutatis mutandis to any other aspect thereof).

An aspect of the present disclosure relates to a mobile communication network.

According to an embodiment, the mobile communication network comprises a plurality of network nodes configured to implement network functions for service provisioning to users of the mobile communication network.

According to an embodiment, the mobile communication network comprises a self-organizing network, SON, module configured to determine optimal configurations of the plurality of network nodes according to working conditions thereof.

According to an embodiment, the mobile communication network comprises a plurality of network resource controllers configured to perform near-real-time control of access network resources used by the plurality of network nodes for service provisioning on a user request basis.

According to an embodiment, the mobile communication network comprises a network resource model, NRM, management module configured to manage configurations of the plurality of network resource controllers.

According to an embodiment, the mobile communication network comprises an orchestration module communicably coupled to the SON module and the NRM management module. According to an embodiment, the orchestration module is configured to, in response to detection of an issue affecting the mobile communication network:
retrieve performance data indicative of performance of the mobile communication network;
retrieve configuration data indicative of at least one between a configuration of at least one network node, among the plurality of network nodes, being involved by said issue, and a configuration of at least one network resource controller, among the plurality of network resource controllers, being involved by said issue, and
based on the performance data and configuration data, and on one or more among a type of issue, a type of service, a type of users, available configurations for the plurality of network resource controllers, and available self-organizing network algorithms, enable an operation of at least one between the SON module and the NRM management module to determine a reconfiguration of at least one between the at least one network node and the at least one network resource controller.

According to an embodiment, the orchestration module is configured to coordinately enable the operation of the SON module and of the NRM management module to determine the reconfiguration of the at least one network node and of the at least one network resource controller on different times.

According to an embodiment, the configurations of the plurality of network resource controllers comprise policy configurations of the plurality of network resource controllers.

According to an embodiment, the available configurations for the plurality of network resource controllers comprise available policy configurations for the plurality of network resource controllers.

According to an embodiment, the orchestration module is configured to detect the issue affecting the mobile communication network according to a notice of critical event generated by at least one among one or more network nodes among said plurality of network nodes, one or more network resource controllers among said plurality of network resource controllers, and one or more analysis modules of the mobile communication network configured to provide the performance data. According to an embodiment, the at least one network node comprises said one or more network nodes.

According to an embodiment, the at least one network resource controller comprises said one or more network resource controllers.

According to an embodiment, the at least one network node further comprises one or more adjacent network nodes, among said plurality of network nodes, being adjacent to said one or more network nodes.

According to an embodiment, the at least one network resource controller further comprises one or more adjacent network resource controllers, among said plurality of network resource controllers, being associated with said one or more adjacent network nodes.

According to an embodiment, the mobile communication network further comprises a cloud computing platform configured to provide a virtualization of the network nodes.

According to an embodiment, in response to detection of the issue affecting the mobile communication network the orchestration module is further configured to retrieve physical resource occupation data indicative of physical resources of the cloud computing platform being occupied by at least one between the at least one network node and the at least one network resource controller, and to determine a reconfiguration of the physical resources of the cloud computing platform being occupied by the at least one between the at least one network node and the at least one network resource controller additionally to said reconfiguration of the at least one between the at least one network node and the at least one network resource controller.

According to an embodiment, the mobile communication network further comprises a configuration module configured to store current configurations of the plurality of network nodes and of the plurality of network resource controllers.

According to an embodiment, the orchestration module is further configured to update the configuration module according to the reconfiguration of the at least one between the at least one network node and the at least one network resource controller.

According to an embodiment, the configuration module is further configured to store current configurations of the physical resources of the cloud computing platform being occupied by the plurality of network nodes and by the plurality of network resource controllers.

According to an embodiment, the orchestration module is configured to update the configuration module according to the reconfiguration of the at least one among the at least one network node, the at least one network resource controller, and the physical resources of the cloud computing platform.

According to an embodiment, the working conditions of the plurality of network nodes are determined based on Fault, Configuration, Accounting, Performance and Security, FCAPS, functionality.

According to an embodiment, the mobile communication network is compliant with the Open Radio Access Network architecture.

According to an embodiment, said plurality of network resource controllers comprise a plurality of near-real-time RAN Intelligent Controllers.

According to an embodiment, said NRM management module comprises a non-real-time RAN Intelligent Controller.

Another aspect of the present disclosure relates to a method for operating a mobile communication network comprising a plurality of network nodes configured to implement network functions for service provisioning to users of the mobile communication network, and a plurality of network resource controllers configured to perform near-real-time control of access network resources used by the plurality of network nodes for service provisioning on a user request basis.

According to an embodiment, the method comprises, in response to detection of an issue affecting the mobile communication network, the following steps (or at least a subset thereof):
retrieving performance data indicative of performance of the mobile communication network;
retrieving configuration data indicative of at least one between a configuration of at least one network node, among the plurality of network nodes, being involved by said issue, and a configuration of at least one network resource controller, among said plurality of network resource controllers, being involved by said issue, and
based on the performance data and configuration data, and on one or more among a type of issue, a type of service, a type of users, available configurations for the plurality of network resource controllers, and available self-organizing network algorithms, determining a reconfiguration of at least one between the at least one network node and the at least one network resource controller by enabling an operation of at least one between a self-organizing network module configured to determine optimal configurations of the plurality of network nodes according to working conditions thereof and a network resource model management module configured to manage configurations of the plurality of network resource controllers.

Another aspect of the present disclosure relates to a mobile terminal for use in the mobile communication network of above.

The present disclosure allows managing and orchestrating two types of network management services in a coordinated way, so as to jointly optimize both end user services (e.g., SLA, QoS, QoE) and overall network performance (e.g., capacity, energy consumption, computational/processing resources). Management and orchestration are hence performed dynamically over time based not only on end users trigger (e.g., service requests), but also on internal network modules triggers (e.g., specific constraints on processing, energy, and configurations) and on overall user equipment and network needs/requirements (continuous local/global optimization)

### BRIEF DESCRIPTION OF THE DRAWINGS

These and other features and advantages of the disclosure will be made apparent by the following description of some exemplary and non-limitative embodiments thereof. For its better intelligibility, the following description should be read making reference to the attached drawings, wherein:
FIG. 1 schematically shows a mobile communication network according to embodiments of the present disclosure, and

FIG. 2 shows a method implemented by the mobile communication network of FIG. 1 according to embodiments of the present disclosure.

### DETAILED DESCRIPTION OF EMBODIMENTS OF THE PRESENT DISCLOSURE

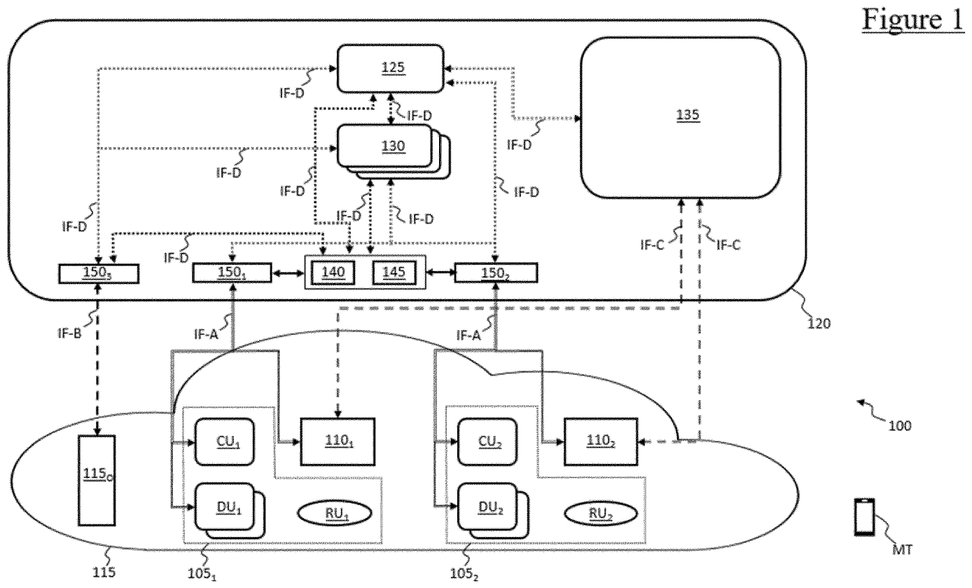

With reference to the drawings, FIG. 1 schematically shows a mobile communication network 100 (e.g., a portion thereof) according to embodiments of the present disclosure.

In the following, when one or more features of the mobile communication network 100 (and of a method implemented by it) are introduced by the wording “according to an embodiment”, they are to be construed as features additional or alternative to any features previously introduced, unless otherwise indicated and/or unless there is evident incompatibility among feature combinations that is immediately apparent to the person skilled in the art.

In the following, the terms “node”, “module”, “platform” and “unit” are intended to emphasize functional (rather than implementation) aspects thereof. Without losing generality, each node and/or module and/or platform and/or unit of the mobile communication network 100 may be implemented by software, hardware, and/or a combination thereof. In addition, each node and/or module and/or platform and/or unit of the mobile communication network 100 (or at least a subset thereof) may also reflect, at least conceptually, physical structures of the mobile communication network 100 (or at least of one or more portions thereof).

According to an embodiment, the mobile communication network 100 may be a 4G mobile communication network or a 5G mobile communication network. Without losing generality, the principles of the present disclosure may be applied to any mobile communication network.

According to an embodiment, the mobile communication network 100 is compliant with the Open Radio Access Network (O-RAN) architecture, for example the O-RAN architecture disclosed in “O-RAN Use Cases and Deployment Scenarios, Towards Open and Smart RAN”, February 2020. Without losing generality, the principles of the present disclosure may be adopted and/or adapted to other architectures.

According to an embodiment, the mobile communication network 100 comprises (e.g., at a radio side thereof) a plurality of network nodes configured to implement network functions (e.g., for service provisioning to users of the mobile communication network). Without losing generality, each network node or group of network nodes may be configured to implement one or more network functions. Just as an example, each network function or group of network functions may correspond to respective one or more services. Additionally or alternatively, each network function or group of network functions may be provided by (or associated with) a respective vendor (multi-vendor scenario).

In the illustrated (not limitative) embodiment, two network nodes 105₁,105₂ are provided. In the following, whenever the network nodes 105₁,105₂ are cited, reference is intended to be made to the plurality of network nodes (or to a subset thereof) of the mobile communication network 100.

In the considered embodiment in which the mobile communication network 100 is compliant with the O-RAN architecture, the network nodes 105₁, 105₂ may be configured to implement O-RAN network functions.

According to an embodiment, the network nodes 105₁,105₂ (or at least a subset thereof) comprise physical network nodes or virtualized network nodes.

According to an embodiment, the (physical or virtualized) network nodes 105₁,105₂ (or at least a subset thereof) comprise monolithic units or components (i.e., all-in-one solutions implementing each and every protocol stack layer), or disaggregated or split units or components (e.g., but not limited to, CU (Central Unit), DU (Distributed Unit), RU (Radio Unit)).

In the considered embodiment in which the mobile communication network 100 is compliant with the O-RAN architecture, each network node 105₁,105₂ may comprise a respective O-RAN Central Unit (O-CU) CU₁, CU₂ (or more thereof). According to an embodiment, each O-CU CU₁, CU₂ comprises a logical node hosting RRC, SDAP and PDCP protocols. Without losing generality, each O-CU CU₁, CU₂ may be based on any protocols or future protocols additional or alternative to one or more among RRC, SDAP and PDCP protocols. Without losing generality, the O-CUs CU₁, CU₂ (or at least a subset thereof) comprise physical O-CUs or virtualized O-CUs.

In the considered embodiment in which the mobile communication network 100 is compliant with the O-RAN architecture, each network node 105₁,105₂ may comprise a respective O-RAN Distributed Unit (O-DU) DU₁, DU₂ (or more thereof). According to an embodiment, each O-DU DU₁, DU₂ comprises a logical node hosting RLC/MAC/High-PHY layers based on a lower layer functional split. Without losing generality, each O-DU DU₁, DU₂ may be based on any layers or future layers additional or alternative to one or more among RLC/MAC/High-PHY layers. Without losing generality, the O-DUs DU₁, DU₂ (or at least a subset thereof) comprise physical O-DUs or virtualized O-DUs.

In the considered embodiment in which the mobile communication network 100 is compliant with the O-RAN architecture, each network node 105₁,105₂ may comprise a respective O-RAN Radio Unit (O-RU) RU₁, RU₂ (or more thereof). According to an embodiment, each O-RU RU₁, RU₂ comprises a logical node hosting Low-PHY layer and RF processing based on a lower layer functional split. Without losing generality, each O-RU RU₁, RU₂ may be based on any layers or future layers additional or alternative to Low-PHY layer. Without losing generality, the O-RUs RU₁, RU₂ (or at least a subset thereof) comprise physical O-RUs or virtualized O-RUs.

According to an embodiment, each O-RU or each group of O-RUs may be based on a respective Radio Access Technology (multi-RAT scenario).

In the following, the O-CUs, the O-DUs and the O-RUs will be also globally denoted as O-RAN units, when distinguishing among them is not relevant for the understanding of the discussed feature(s).

According to an embodiment, the O-RAN units (or at least a subset thereof) are communicably couplable to mobile terminals, such as the mobile terminal MT. According to an embodiment, the mobile terminal MIT is adapted to be used in the mobile communication network 100.

According to an embodiment, each mobile terminal, such as the mobile terminal MT, allows a respective user (for example, an owner of the mobile terminal) to access services delivered by the mobile communication network 100.

Examples of mobile terminals include, but are not limited to portable devices, such as smartphones and tablets.

According to an embodiment, the mobile communication network 100 comprises (e.g., at the radio side thereof) one or more Network Resource Controllers (hereinafter, NRC controllers) configured to perform near-real-time control of (or, concisely, to manage) access network resources used by the network nodes 105₁,105₂ for service provisioning on a user request basis.

In the illustrated (not limitative) embodiment, two NRC controllers 110₁,110₂ are provided. In the illustrated (not limitative) embodiment, each NRC controller 110₁,110₂ is associated with (i.e., configured to manage access network resources used by) a respective network node 105₁,105₂. Just as a non-limitative example, each NRC controller 110₁,110₂ may be specific for each vendor and/or for each service.

In the considered embodiment in which the mobile communication network 100 is compliant with the O-RAN architecture, each NRC controller 110₁,110₂ may comprise an O-RAN near-real-time RAN Intelligent Controller (hereinafter referred to as Near-RT RIC).

According to an embodiment, each Near-RT RIC is a platform node where multiple and independent software plug-in or applications (referred to as “xApps”), not shown, can run concurrently for carrying out corresponding tasks and for providing functional extensibility to the RAN directly by an operator of the mobile communication network 100 or by third parties. Examples of tasks include, but are not limited to, monitoring of potentials network faults, handling of Quality of Experience (QoE), handling of Quality of Service (QoS), handling of network traffic balance, handling of network interference. According to an embodiment, each Near-RT RIC is configured to control xApp execution based on machine learning and/or artificial intelligence algorithms.

For the purposes of the present disclosure, the xApps allow controlling Radio Resource Management (RRM) decisions for individual RAN functionalities at near-real-time granularities (i.e., of the order of 10 ms-1 sec). Otherwise stated, the xApps allow providing near-real-time control and optimization of the O-RAN units and of the access network resources. Without losing generality, RRM decisions may be aimed at controlling parameters including, but not limited to, transmit power, user allocation, beamforming, data rates, handover criteria, modulation scheme, and error coding scheme.

According to an embodiment, one or more of the network nodes 105₁,105₂ (such as one or more among the respective O-RAN units, for example one or more among the respective O-CUs CU₁, CU₂ and O-DUs DU₁, DU₂), and/or one or more of the NRC controllers 110₁,110₂ (such as one or more of the Near-RT RICs) may be targeted for an optimization process (as better discussed in the following).

According to an embodiment, the mobile communication network 100 comprises (e.g., at the radio side thereof) a cloud computing platform 115 configured to provide a virtualization of the network nodes 105₁,105₂ (and, hence, for supporting the execution of the corresponding network functions in a virtualized environment, or, otherwise stated, for decoupling the network functions from specific hardware). As mentioned above, embodiments may be envisaged in which the network nodes 105₁,105₂ (such as the O-RAN units) comprise physical network nodes; in these embodiments, the cloud computing platform 115 may be omitted or provided for other purposes.

In the considered embodiment in which the mobile communication network 100 is compliant with the O-RAN architecture, the cloud computing platform 115 may comprise a computing platform, commonly referred to as the O-RAN Cloud Platform or O-Cloud, for supporting the execution of the O-RAN network functions. For the purposes of the present disclosure, the O-Cloud is a cloud computing platform comprising a collection of physical infrastructure modules (in the following, physical resources) that meet O-RAN requirements to host the relevant O-RAN network functions (including, but not limited to, the O-CUs, O-DUs, and Near-RT RICs), the supporting software components (such as Operating System, Virtual Machine Monitor, and Container Runtime), not shown, and a Network Function Virtualization Orchestration (NFVO) module 115_{O} (or more thereof) configured to provide management and orchestration functions for the physical resources of the cloud computing platform 115.

In alternative embodiments (not shown) in which no virtualization of the network nodes is provided, the cloud computing platform 115 may be omitted.

According to an embodiment, the mobile communication network 100 comprises (e.g., at a management side thereof) a Service Management and Orchestration (SMO) framework 120.

According to an embodiment, the SMO framework 120 comprises an orchestration module 125. For the purposes of the present disclosure, the orchestration module 125 is configured to manage the optimization process. According to an embodiment, the orchestration module 125 is a centralized multi-vendor and multi-technology module. According to an embodiment, the orchestration module 125 is configured to operate based on network data from (or related to) the network nodes 105₁,105₂ and/or the NRC controllers 110₁,110₂, and/or the cloud computing platform 115. According to an embodiment, as better discussed in the following, the network data may comprise (but are not limited to) one or more (preferably all) among performance data indicative of performance of the mobile communication network 100 (or of a portion thereof), configuration data indicative of configurations of the network nodes 105₁,105₂ and/or of the NRC controllers 110₁,110₂ and/or of the physical resources of the cloud computing platform 115 being occupied by the network nodes 105₁,105₂ and the NRC controllers 110₁,110₂.

Examples of performance data include, but are not limited to, one or more network node performance measurements (i.e., one or more performance measurements associated with and/or performed by one or more of the network nodes 105₁,105₂), and one or more NRC controller performance measurements (i.e., one or more performance measurements associated with and/or performed by one or more of the NRC controllers 110₁,110₂).

An example of network node performance measurement includes, but is not limited to, UL PDCP SDU Loss Rate (Packet Loss rate) at GNBCUUPFunction level (see, for example, the 3GPP technical specification TS 28.552:“3rd Generation Partnership Project; Technical Specification Group Services and System Aspects; Management and orchestration; 5G performance measurements (Release 16)”). Other examples of network node performance measurements will be apparent from the exemplary use case scenarios discussed in the following.

An example of NRC controller performance measurement includes, but is not limited to, Peak DL PRB at NRCellDU level (see the above-cited 3GPP technical specification TS 28.552). Other examples of NRC controller performance measurements will be apparent from the exemplary use case scenarios discussed in the following.

Examples of configuration data indicative of configurations of the network nodes 105₁,105₂ include, but are not limited to, antenna/beam parameters such as beamAzimuth, beamTilt, beamHorizWidth and beam VertWidth (see, for example, the 3GPP technical specification TS 28.541: “Technical Specification Group Services and System Aspects; Management and orchestration; 5G Network Resource Model (NRM); Stage 2 and stage 3 (Release 16)”), and cell load parameters. Other examples of configuration data indicative of configurations of the network nodes 105₁,105₂ will be apparent from the exemplary use case scenarios discussed in the following.

Examples of configuration data indicative of configurations of the NRC controllers 110₁,110₂ include, but are not limited to, handover parameters and RRM algorithm policy parameters. Examples of RRM algorithm policy parameters include, but are not limited to, RRMPolicyRatio parameters such as rRMPolicy MaxRatio (i.e., maximum resource usage quota for the associated rRMPolicyMemberList), rRMPolicyMinRatio (i.e., minimum resource usage quota for the associated rRMPolicyMemberList) and rRMPolicyDedicatedRatio (i.e., dedicated resource usage quota for the associated rRMPolicyMemberList)-see, for example, the above-cited 3GPP technical specification TS 28.541. Other examples of configuration data indicative of configurations of the NRC controllers 110₁,110₂ will be apparent from the exemplary use case scenarios discussed in the following.

According to an embodiment, the SMO framework 120 comprises a Self-Organising Network (SON) module 130 (or more thereof) configured to determine optimal configurations of the network nodes 105₁,105₂ according to working conditions thereof. According to an embodiment, the working conditions of the network nodes 105₁, 105₂ are determined based on Fault, Configuration, Accounting, Performance and Security, FCAPS, functionality. According to an embodiment, the SON module 130 is configured to determine the optimal configurations of the network nodes 105₁,105₂ according to the network data (or a subset thereof). According to an embodiment, the SON module 130 is communicably coupled to the orchestration module 125 (for example, through an internal interface of the SMO framework 120, as discussed in the following).

According to an embodiment, the SMO framework 120 comprises a Network Resource Model (NRM) management module 135 (or more thereof) configured to manage the NRC controllers 110₁,110₂ (or at least of a subset thereof). For the purposes of the present disclosure, the NRM management module 135 is configured to manage configurations, for example policy configurations, of the NRC controllers 110₁,110₂ (or at least of a subset thereof).

In the considered embodiment in which the mobile communication network 100 is compliant with the O-RAN architecture, the NRM management module 135 may comprise a non-real-time RAN Intelligent Controller (hereinafter referred to as Non-RT RIC). According to an embodiment, the Non-RT RIC comprises one or more logical functions providing one or more among non-real-time control and optimization of the O-RAN units and of the access network resources, artificial intelligence and/or machine learning workflows including model training and updates, and policy-based guidance of applications/features in Near-RT RIC controllers. According to an embodiment, the Non-RT RIC controller is a platform node as defined in O-RAN alliance, i.e., a platform node where multiple and independent software plug-in or applications (referred to as “rApps”), not shown, can run concurrently for providing additional value-added services to help creation of policies to be delivered to the Near-RT RICs.

According to an embodiment, the NRM management module 135 is communicably coupled to the orchestration module 125 (for example, through the internal interface of the SMO framework 120, as discussed in the following).

According to an embodiment, the SMO framework 120 comprises an analysis module 140 (or more thereof) configured to receive (from the network nodes 105₁,105₂ and/or from the NRC controllers 110₁,110₂ and/or from other entities of, or connected to, the mobile communication network 100, not shown) the performance data (or an indication thereof, such as one or more corresponding performance indicators, for example Key Performance Indicators, or KPIs).

According to an embodiment, the analysis module 140 is communicably coupled to the orchestration module 125 and/or to the SON module 130 (for example, through the internal interface of the SMO framework 120, as discussed in the following). According to an embodiment, the analysis module 140 is communicably coupled to the orchestration module 125 and/or to the SON module 130 to provide the performance data (or an indication thereof, such as one or more corresponding performance indicators, for example Key Performance Indicators, or KPIs) to the orchestration module 125 and/or the SON module 130. As better discussed in the following, according to an embodiment, the orchestration module 125 is configured to retrieve the performance data (for example, from the analysis module 140) in response to detection of an issue affecting the mobile communication network 100.

According to an embodiment, the orchestration module 125 and/or the SON module 130 are configured to operate based on current performance data (i.e., the performance data related to a time interval substantially corresponding (or at least close to) the time interval during which the optimization process is run). Without losing generality, the orchestration module 125 and/or the SON module 130 may be configured to operate, additionally or alternatively, based on historical performance data (i.e., the performance data related to one or more time intervals before the time interval during which the optimization process is run).

According to an embodiment, the SMO framework 120 comprises a configuration module 145 (or more thereof) configured to store the configuration data (i.e., the data indicative of the configurations of the network nodes 105₁,105₂, of the NRC controllers 110₁,110₂, and/or of the physical resources of the cloud computing platform 115 being occupied by them). According to an embodiment, the configuration module 145 is communicably coupled to the orchestration module 125 and/or to the SON module 130 (for example, through the internal interface of the SMO framework 120, as discussed in the following). According to an embodiment, the configuration module 145 is communicably coupled to the orchestration module 125 and/or to the SON module 130 to provide the configuration data (or an indication thereof) to the orchestration module 125 and/or the SON module 130. As better discussed in the following, according to an embodiment, the orchestration module 125 is configured to retrieve the configuration data (e.g., from the configuration module 145) in response to detection of an issue affecting the mobile communication network 100.

According to an embodiment, the orchestration module 125 and/or the SON module 130 are configured to operate based on current configuration data (i.e., the configuration data related to a time interval substantially corresponding (or at least close to) the time interval during which the optimization process is run). Without losing generality, the orchestration module 125 and/or the SON module 130 may be configured to operate, additionally or alternatively, based on historical configuration data (i.e., the configuration data related to one or more time intervals before the time interval during which the optimization process is run).

According to an embodiment, the SMO framework 120 comprises one or more Exposure Governance Management Function (EGMF) modules configured to provide exposure of services and related data (hereinafter, service/data exposure) to and/or from the network nodes 105₁,105₂ and/or the NRC controllers 110₁,110₂. Without losing generality, service/data exposure to and/or from the network nodes 105₁,105₂ and/or the NRC controllers 110₁,110₂ may comprise service/data exposure for FCAPS (Fault, Configuration, Accounting, Performance and Security) management.

For the purposes of the present disclosure, service/data exposure to and/or from the network nodes 105₁, 105₂ and/or the NRC controllers 110₁, 110₂ may comprise the provision of the performance and configuration data from the network nodes 105₁,105₂ and/or the NRC controllers 110₁,110₂.

For the purposes of the present disclosure, service/data exposure to and/or from the network nodes 105₁,105₂ and/or the NRC controllers 110₁,110₂ may comprise provision of reconfiguration data to the network nodes 105₁,105₂ (hereinafter referred to as node reconfiguration data) aimed at reconfiguring the network nodes 105₁,105₂ based on the optimization process.

In the exemplary illustrated embodiment, the EGMF modules comprises an EGMF module 1501 associated with (i.e., for providing service/data exposure to and/or from) the network node 1051 and/or the NRC controller 1101, and an EGMF module 1502 associated with (i.e., for providing service/data exposure to and/or from) the network node 1052 and/or the NRC controller 1102.

According to an embodiment, each EGMF module 150₁,150₂ is communicably coupled to the analysis module 140 for providing it with the performance data from or related to the associated network node (i.e., the network node 105₁,105₂, respectively) and/or the associated NRC controller (i.e., the NRC controller 110₁,110₂, respectively).

According to an embodiment, each EGMF module 150₁,150₂ is communicably coupled to the configuration module 145 for providing it with the configuration data from or related to the associated network node (i.e., the network node 105₁,105₂, respectively) and/or the associated NRC controller (i.e., the NRC controller 110₁,110₂, respectively).

According to an embodiment, the SMO framework 120 comprises an EGMF module 150₃ configured to provide service/data exposure to and/or from the NFVO module 115_{O}.

For the purposes of the present disclosure, service/data exposure to and/or from the NFVO module 115_{O} may comprise the provision of the resource occupation data from the NFVO module 115_{O}.

For the purposes of the present disclosure, service/data exposure to and/or from the NFVO module 115_{O} may comprise the provision of reconfiguration data to the NFVO module 115_{O} (hereinafter referred to as resource occupation reconfiguration data) aimed at reconfiguring the occupation of the physical resources of the cloud computing platform 115 based on the optimization process.

According to an embodiment, the EGMF module 1503 is communicably coupled to the configuration module 145 (for example, through the internal interface of the SMO framework 120, as discussed in the following) for providing it with the resource occupation data (or an indication thereof).

According to an embodiment, the mobile communication network 100 comprises a plurality of interfaces (discussed here below), or a subset thereof, which are graphically represented in the figure by connection lines with different graphical effects.

According to an embodiment, the mobile communication network 100 comprises an interface IF-A between the network nodes 105₁,105₂ (e.g., the O-CUs CU₁, CU₂, O-DUs DU₁, DU₂) and the NRC controllers (e.g., the Near-RT RICs) 110₁,110₂, and the SMO framework 120 (e.g., the respective EGMF modules, such as the EGMF modules 150₁,150₂). In the considered embodiment in which the mobile communication network 100 is compliant with the O-RAN architecture, the interface IF-A may be the Ol interface.

According to an embodiment, the mobile communication network 100 comprises an interface IF-B between the cloud computing platform 105 (e.g., the NFVO module 115_{O}) and the SMO framework 120 (e.g., the respective EGMF modules, such as the EGMF module 1503). In the considered embodiment in which the mobile communication network 100 is compliant with the O-RAN architecture, the interface IF-B may be the O2 interface.

According to an embodiment, the mobile communication network 100 comprises an interface IF-C between the NRC controllers (e.g., the near-RT RICs) 110₁,110₂ and the NRM management module (e.g., the non-RT RIC) 135, e.g., for real-time/near-real time activity management. For the purposes of the present disclosure, the interface IF-C allows management of reconfiguration data from the NRM management module (e.g., the Non-RT RIC) 135 to the NRC controllers (e.g., the Near-RT RICs) 110₁,110₂ (hereinafter referred to as policy reconfiguration data) aimed at reconfiguring the policies of the (RRM algorithms within the) NRC controllers (e.g., the policies of the (RRM algorithms within the) Near-RT RICs) 110₁,110₂ based on the optimization process (as better discussed in the following). In the considered embodiment in which the mobile communication network 100 is compliant with the O-RAN architecture, the interface IF-C may be the A1 interface.

According to an embodiment, the mobile communication network 100 comprises an interface (for example, an internal interface of the SMO framework 120, referred to as internal interface) IF-D between the orchestration module 125 and one or more (preferably all) among the SON module 130, the NRM management module (e.g., the Non-RT RIC) 135, the analysis module 140, the configuration module 145, and the EGMF modules 150₁,150₂,150₃ (or at least a subset thereof), between the SON module 130 and one or more (preferably all) among the analysis module 140, the configuration module 145 and the EGMF modules 150₁,150₂,150₃ (or at least a subset thereof), between each EGMF module 150₁,150₂ and one or both between the analysis module 140 and the configuration module 145, and between the EGMF module 1503 and the configuration module 145. Without losing generality, dedicated interfaces (additional or alternative to the internal interface IF-D) may be envisaged for interfacing one or more among the orchestration module 125, the SON module 130, the NRM management module 135, the analysis module 140, the configuration module 145, the EGMF modules 150₁,150₂,150₃ (or at least a subset thereof) to each other, for example in order to address specific type of services.

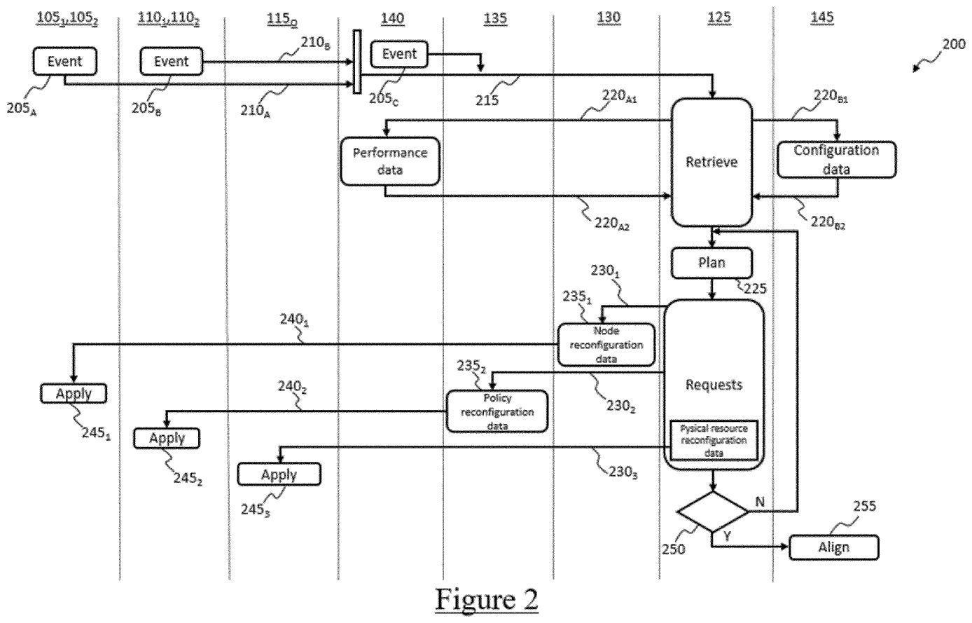

With reference now to FIG. 2, it shows an activity diagram of a method 200 (implementing the optimization process) according to embodiments of the present disclosure. Particularly, FIG. 2 shows a swim-lane activity diagram which describes the flow of activities relating to exemplary embodiments of the present disclosure. In this respect, each step of the activity diagram may correspond to one or more executable instructions for implementing the specified logical function(s) on a relevant software component of a respective actor. Without losing generality, the following actors are exemplary considered as being involved in the optimization process: the network nodes 105₁,105₂, the NRC controllers 110₁,110₂, the NFVO module 115_{O}, the analysis module 140, the NRM management module 135, the SON module 130, the orchestration module 125, and the configuration module 145.

According to an embodiment, the method steps may be implemented by respective computer program products loadable into a digital memory of the actors (i.e., a digital memory of computational resources where the actors are implemented). According to an embodiment, each computer program product comprises software code means for performing the method steps when the computer program product is run on the corresponding actor.

As will be understood from the following discussion, the method 200 is aimed at optimizing service requirements of users with respect to available radio and computational resources, by operating at the RRM level (i.e., at the NRC controller level) and/or at the SON/FCAPS level depending on a detected issue affecting the mobile communication network 100 (hereinafter concisely referred to as network issue).

For the purposes of the present disclosure, a network issue comprises any issue or criticality or problem affecting the mobile communication network 100 (or at least a portion thereof). In the exemplary considered embodiment, the network issues are detected by the SMO framework 120 (e.g., by the orchestration module 125) upon reception of notices of critical events occurring at one or more network apparatuses of the mobile communication network 100.

According to an embodiment, the method 200 comprises generating a notice of a critical event, or more thereof (steps 205_{A}, 205_{B}, 205_{C}).

According to an embodiment, the critical event may occur at (and the corresponding notice of critical event may be generated by) one or more of the network nodes 105₁,105₂ (step 205_{A}) and/or one or more of the NRC controllers 110₁,110₂ (step 205_{B}) and/or the analysis module 140 (step 205_{C}). Additional or alternatively, one or more critical events may occur at (and the corresponding notices of critical events may be generated by) one or more network apparatuses other than the network nodes 105₁,105₂, the NRC controllers 110₁, 110₂ and the analysis module 140.

An example of critical event that may occur at the one or more of the network nodes 105₁, 105₂ includes, but is not limited to, one or more network node performance measurements (such as the UL PDCP SDU Loss Rate) crossing one or more predefined thresholds.

An example of critical event that may occur at the one or more of the NRC controllers 110₁,110₂ includes, but is not limited to, one or more NRC controller performance measurements (such as the Peak DL PRB) crossing one or more predefined thresholds.

According to an embodiment, the method 200 comprises transmitting (by the network node(s) 105₁,105₂ and/or by the NRC controller(s) 110₁,110₂) the notice of critical event to the analysis module 140 (steps 210_{A},210_{B}), and transmitting the notice of critical event from the analysis module 140 to the orchestration module 125 (step 215). Without losing generality, the notice of critical event may be transmitted (by the network node(s) 105₁,105₂ and/or by the NRC controller(s) 110₁,110₂) to the respective EGMF module(s) 150₁,150₂ through the interface IF-A, thereafter the notice of critical event (or at least an indication thereof) may be transmitted (by the respective EGMF module(s) 150₁,150₂) to the analysis module 140 through the internal interface IF-D, then the notice of critical event (or at least an indication thereof) may be transmitted to the orchestration module 125 through the internal interface IF-D.

According to an embodiment, the method 200 comprises, at the orchestration module 125, in response to detection of the network issue (e.g., upon reception of the notice of critical event), retrieving the performance data and the configuration data.

According to an embodiment, the performance data are retrieved from the analysis module 140 (e.g., through the internal interface IF-D). According to an embodiment, in order to retrieve the performance data from the analysis module 140, the orchestration module 125 may be configured to transmit (e.g., through the internal interface IF-D) a corresponding request to the analysis module 140 (step 220_{A1}), and the analysis module 140 may be configured to transmit (e.g., through the internal interface IF-D) the performance data to the orchestration module 125 (step 220_{A2}).

According to an embodiment, the configuration data are retrieved from the configuration module 145 (e.g., through the internal interface IF-D). According to an embodiment, in order to retrieve the configuration data from the configuration module 145, the orchestration module 125 may be configured to transmit (e.g., through the internal interface IF-D) a corresponding request to the configuration module 145 (step 220_{B1}), and the configuration module 145 may be configured to transmit (e.g., through the internal interface IF-D) the configuration data to the orchestration module 125 (step 220_{B2}).

According to an embodiment, the retrieved performance data may comprise the network node performance measurements of one or more network nodes, among the (plurality of) network nodes 105₁,105₂, being involved by the network issue (in the following also referred to as involved network node(s)), and/or the NRC controller performance measurements of one or more NRC controllers, among the (plurality of) NRC controllers 110₁,110₂, being involved by the network issue (in the following also referred to as involved NRC controller(s)). Without losing generality, the retrieved performance data may comprise the current (or both current and historical) network node performance measurements of the involved network node(s), and/or the current (or both current and historical) NRC controller performance measurements of the involved NRC controller(s).

According to an embodiment, the retrieved configuration data is indicative of a configuration of the involved network node(s), and/or of a configuration of the involved NRC controller(s). Without losing generality, the retrieved configuration data may be indicative of the current (or both current and historical) configurations of the involved network node(s), and/or of the current (or both current and historical) configurations of the involved NRC controller(s).

According to an embodiment, an involved network node may be a network node having generated the notice of critical event. According to an embodiment, an involved NRC controller may be an NRC controller having generated the notice of critical event.

Without losing generality, an involved network node may be a network node associated with an NRC controller having generated the notice of critical event, and/or an adjacent network node being adjacent to a network node having generated the notice of critical event.

Without losing generality, an involved NRC controller may be an NRC controller associated with a network node having generated the notice of critical event, and/or an adjacent NRC controller associated with an adjacent network node.

According to an embodiment, the method 200 comprises, at the orchestration module 125, enabling (or planning or orchestrating) an operation of the SON module 130 and/or of the NRM management module 135 to determine a reconfiguration of the involved network node(s), and/or of the involved NRC controller(s), and/or of the physical resources of the cloud computing platform being occupied by the involved network node(s) and NRC controller(s)-step 225.

According to an embodiment, the orchestration module 125 is configured to enable the operation of the SON module 130 and/or of the NRM management module 135 (to determine one or more of the reconfigurations) based on the (retrieved) performance and configuration data, and on one or more among a type of network issue, a type of service, a type of users, available configurations (such as available policy configurations) for the NRC controllers (particularly, available configurations, such as policy configurations, that are available for the involved NRC controller(s)), and available SON algorithms (i.e., the SON algorithms that are available at the SON module 130).

Just as an exemplary use case scenario, in case of network issue affecting a single user or a single service session, the optimization process may take place only (or mainly) at RRM level. Therefore, in this case, the orchestration module 125 may be configured to enable (only) the operation of the NRM management module 135.

Just as another exemplary use case scenario, in case of network issue affecting a group of users (such as, but not limited to, priority-class users distributed over an area that has congestion problems, e.g., due to a traffic peak), the optimization process may take place both at SON level (e.g., in order to obtain a more uniform spatial distribution of the users, for example by using a Mobility Load Balancing (MLB) algorithm allowing some users to access network nodes (other than the involved network node (s)) not impaired by the traffic peak), and at RRM level (e.g., to manage ongoing and future user connections to ensure the requested QoS). Therefore, in this case, the orchestration module 125 may be configured to enable the operation (e.g., the concurrent operation) of both the SON module 130 and the NRM management module 135.

Just as a further exemplary use case scenario, in case of network issue affecting an NRC controller (for example, in that the NRC controller is not capable of disposing a dedicated queue for users having guaranteed quality parameters, such as due to cell load or interference problems causing a filling level of the Downlink (DL) buffer for the radio resources dedicated to these users to exceed a certain maximum limit), the optimization process may take place at SON level (e.g., in order to move users by changing the radioelectric context, for example by means of a Coverage and Capacity Optimization (CCO) algorithm). Therefore, in this case, the orchestration module 125 may be configured to enable the operation of the SON module 130 (although the network issue affects an NRC controller).

According to an embodiment, the orchestration module 125 may be configured to coordinately enable the operation of the SON module 130 and of the NRM management module 135 to determine the reconfiguration of the involved network node(s) and/or of the involved NRC controller(s) on different times.

Just as an exemplary use case scenario, in case that an NRC controller is not capable of disposing a dedicated queue for users having guaranteed quality parameters (for example, due to cell load or interference problems causing a filling level of the Downlink (DL) buffer for the radio resources dedicated to these users to exceed a certain maximum limit), the optimization process may at first take place at the RRM level (for example, by setting proper handovers), then it may take place at the SON level (e.g., in order to move users by changing the antenna/beam parameters (for example by means of a Coverage and Capacity Optimization (CCO) algorithm), and/or cell load parameters (for example, by means of a Mobility Load Balancing (MLB) algorithm) at a later time (for example, in case of failure of the optimization process performed at the RRM level, e.g., in that users may return to the same cell).

According to an embodiment, the method 200 comprises, at the orchestration module 125, coordinating the optimization process for the involved network node(s) and/or the involved NRC controller(s) and/or the involved physical resource(s) reconfigurations to determine the respective configurations (steps 230₁,230₂,230₃, discussed here below).

According to an embodiment, the method 200 may comprise, at the orchestration module 125, transmitting to the SON module 130 (e.g., through the internal interface IF-D), a node reconfiguration request for performing a node reconfiguration of the involved network node(s) based on a selected SON algorithm (step 230₁).

According to an embodiment, the method 200 may comprise, at the orchestration module 125, transmitting to the NRM management module 135 (e.g., through the internal interface IF-D) a policy reconfiguration request for reconfiguring the policies of the active RRM algorithms in the involved NRC controller(s) (step 230₂). Just as an example, the policy reconfiguration request may comprise an indication of the relevant rApps.

According to an embodiment, the method 200 may comprise, at the orchestration module 125, transmitting to the NFVO module 115_{O} a physical resource reconfiguration request for reconfiguring the physical resource(s) occupied by the involved network node(s) and/or the involved NRC controller(s) (step 230₃). According to an embodiment, the physical resource reconfiguration request may comprise the physical resource configuration data (with the physical resource configuration data that may be determined at the orchestration module 125, as conceptually represented in the figure, or at another entity of the SMO framework 120, not shown). According to an embodiment, not shown, the physical resource configuration request (or at least an indication thereof) may be transmitted (by the orchestration module 125) to the EGMF module 150₃ through the interface IF-A, thereafter the physical resource configuration request (or at least an indication thereof) may be transmitted (by the EGMF module 150₃) to the NFVO module 115_{O} through the interface IF-B.

According to an embodiment, the method 200 comprises, in response to the node reconfiguration request (if any), determining, at the SON module 130, an optimal configuration of the involved network node(s) (or, otherwise stated, determining the node reconfiguration data for the involved network node(s), i.e., the node reconfiguration data to be applied for reconfiguring the involved network node(s)) (step 235₁), transmitting the node reconfiguration data from the SON module 130 to the involved network node(s) (step 240₁), and applying the node reconfiguration data to the involved network node(s) to cause reconfiguration thereof (step 245₁). Although not shown, according to an embodiment, transmission of the node reconfiguration data from the SON module 130 to the involved network node(s) comprises transmission of the node reconfiguration data (or at least an indication thereof) to the respective EGMF module(s) (for example, the EGMF module 150₁ if the involved network node(s) comprise the network node 105₁, or the EGMF module 150₂ if the involved network node(s) comprise the network node 105₂) through the internal interface IF-D, and transmission of the node reconfiguration data (or at least an indication thereof) from the respective EGMF module(s) to the (respective) involved network node(s) through the interface IF-A.

According to an embodiment, the method 200 comprises, in response to the policy reconfiguration request (if any), determining, at the NRM management module 135, an optimal policy configuration of the involved NRC controller(s) (or, otherwise stated, determining the policy reconfiguration data for the involved NRC controller(s), i.e., the policy reconfiguration data to be applied for reconfiguring the involved NRC controller(s)) (step 235₂), transmitting the policy reconfiguration data from the NRM management module 145 to the involved NRC controller(s) (step 240₂) and applying the policy reconfiguration data to the involved NRC controller(s) to cause reconfiguration thereof (step 245₂). According to an embodiment, transmission of the policy reconfiguration data from the NRM management module 135 to the involved NRC controller(s) is performed through the interface IF-C.

According to an embodiment, the method 200 comprises, at the NFVO module 115_{O}, in response to the physical resource reconfiguration request (if any), and, in response to determination or reception of the physical resource reconfiguration data for the involved network node(s) and/or NRC controller(s) (i.e., the physical resource reconfiguration data to be applied to the cloud computing platform 115 for reconfiguring the physical resources occupied by the involved network node(s) and/or by the involved NRC controller(s)), applying the physical resource reconfiguration data to the cloud computing platform (step 245₃).

According to an embodiment, the method 200 comprises updating or aligning the configuration module 145 (and, hence, the configuration data stored therein) with the determined and applied node reconfiguration data, if any, with the determined and applied policy reconfiguration data, if any, and with the determined and applied physical resource reconfiguration data, if any (step 255).

According to an embodiment, updating or aligning of the configuration module 145 is performed if the applied node reconfiguration data, if any, the applied policy reconfiguration data, if any, and the applied physical resource reconfiguration data, if any, results in a resolution (or at least an improvement) of the network issue (exit branch Y of step 250).

According to an embodiment, the method 200 comprises, if the applied node reconfiguration data, if any, the applied policy reconfiguration data, if any, and the applied physical resource reconfiguration data, if any, does not result in a resolution (or at least in an improvement) of the network issue (exit branch N of step 250), enabling (or planning or orchestrating), at the orchestration module 125, an operation of the SON module 130 and/or of the NRM management module 135 to determine a further reconfiguration of the involved network node(s), and/or of the involved NRC controller(s), and/or of the physical resources of the cloud computing platform being occupied by the involved network node(s) and NRC controller(s) (as conceptually represented in the figure by arrow connection between exit branch N of step 250 and step 225).

According to an embodiment, the determination at the orchestration module 125 that the applied node reconfiguration data, if any, the applied policy reconfiguration data, if any, and the applied physical resource reconfiguration data, if any, results or does not result in a resolution (or at least an improvement) of the network issue is based on further performance data indicative of the performance of the (reconfigured) mobile communication network 100 with the applied node reconfiguration data, and/or policy reconfiguration data, and/or physical resource reconfiguration data.

Optimization performed by coordinately operating both at the RRM level and at the SON / FCAPS level allows maximizing the effect of each individual action and avoiding conflict situations that could reduce or even cancel the effectiveness of individual interventions.

Optimization performed by operating at the RRM level and/or at the SON/FCAPS level depending on the detected network issue, allows performing optimization at different levels, e.g. (but not limited to) at single user level, and/or at users group level, and/or at network portion level, and/or at single network function level, and/or at service level, or to any combination of the previous levels.

Naturally, in order to satisfy local and specific requirements, a person skilled in the art may apply to the disclosure described above many logical and/or physical modifications and alterations. More specifically, although the present disclosure has been described with a certain degree of particularity with reference to preferred embodiments thereof, it should be understood that various omissions, substitutions and changes in the form and details as well as other embodiments are possible. In particular, different embodiments of the disclosure may even be practiced without the specific details set forth in the preceding description for providing a more thorough understanding thereof; on the contrary, well-known features may have been omitted or simplified in order not to encumber the description with unnecessary details. Moreover, it is expressly intended that specific elements and/or method steps described in connection with any disclosed embodiment of the disclosure may be incorporated in any other embodiment.

More specifically, the present disclosure lends itself to be implemented through an equivalent method (by using similar steps, removing some steps being not essential, or adding further optional steps); moreover, the steps may be performed in different order, concurrently or in an interleaved way (at least partly).

1. A mobile communication network comprising:
a plurality of network nodes configured to implement network functions for service provisioning to users of the mobile communication network;
a self-organizing network (SON) module configured to determine optimal configurations of the plurality of network nodes according to working conditions thereof;
a plurality of network resource controllers configured to perform near-real-time control of access network resources used by the plurality of network nodes for service provisioning on a user request basis;
a network resource model; (NRM), management module configured to manage configurations of the plurality of network resource controllers, ; and
an orchestration module communicably coupled to the SON module and the NRM management module, the orchestration module being configured to, in response to detection of an issue affecting the mobile communication network:
retrieve performance data indicative of performance of the mobile communication network;
retrieve configuration data indicative of at least one between a configuration of at least one network node, among the plurality of network nodes, being involved by the issue, and a configuration of at least one network resource controller, among the plurality of network resource controllers, being involved by the issue; and
based on the performance data and configuration data, and on one or more among a type of issue, a type of service, a type of users, available configurations for the plurality of network resource controllers, and available self-organizing network algorithms, enable an operation of at least one between the SON module and the NRM management module to determine a reconfiguration of at least one between the at least one network node and the at least one network resource controller.

2. The mobile communication network according to claim 1, wherein the orchestration module is configured to coordinately enable the operation of the SON module and of the NRM management module to determine the reconfiguration of the at least one network node and of the at least one network resource controller on different times.

3. The mobile communication network according to claim 1, wherein the configurations of the plurality of network resource controllers comprise policy configurations of the plurality of network resource controllers, and wherein the available configurations for the plurality of network resource controllers comprise available policy configurations for the plurality of network resource controllers.

4. The mobile communication network according to claim 1, wherein the orchestration module is configured to detect the issue affecting the mobile communication network according to a notice of critical event generated by at least one among one or more network nodes among the plurality of network nodes one or more network resource controllers among the plurality of network resource controllers, and one or more analysis modules of the mobile communication network configured to provide the performance data.

5. The mobile communication network according to claim 4, wherein the at least one network node comprises the one or more network nodes, and the at least one network resource controller comprises the one or more network resource controllers.

6. The mobile communication network according to claim 5, wherein the at least one network node further comprises one or more adjacent network nodes, among the plurality of network nodes, being adjacent to the one or more network nodes, and the at least one network resource controller further comprises one or more adjacent network resource controllers, among the plurality of network resource controllers, being associated with the one or more adjacent network nodes.

7. The mobile communication network according to claim 1, further comprising a cloud computing platform configured to provide a virtualization of the network nodes, in response to detection of the issue affecting the mobile communication network the orchestration module being further configured to retrieve physical resource occupation data indicative of physical resources of the cloud computing platform being occupied by at least one between the at least one network node and the at least one network resource controller, and to determine a reconfiguration of the physical resources of the cloud computing platform being occupied by the at least one between the at least one network node and the at least one network resource controller additionally to the reconfiguration of the at least one between the at least one network node and the at least one network resource controller.

8. The mobile communication network according to claim 7, further comprising a configuration module configured to store current configurations of the plurality of network nodes and of the plurality of network resource controllers, wherein the orchestration module is further configured to update the configuration module according to the reconfiguration of the at least one between the at least one network node and the at least one network resource controller.

9. The mobile communication network according to claim 8 when depending on claim 7, wherein the configuration module is further configured to store current configurations of the physical resources of the cloud computing platform being occupied by the plurality of network nodes and by the plurality of network resource controllers, the orchestration module being configured to update the configuration module according to the reconfiguration of the at least one among the at least one network node, the at least one network resource controller, and the physical resources of the cloud computing platform.

10. The mobile communication network according to claim 1, wherein the working conditions of the plurality of network nodes are determined based on Fault, Configuration, Accounting, Performance and Security, FCAPS, functionality.

11. The mobile communication network according to claim 1, wherein the mobile communication network is compliant with the Open Radio Access Network (O-RAN) architecture.

12. The mobile communication network according to claim 11, wherein the plurality of network resource controllers comprise a plurality of near-real-time RAN Intelligent Controllers, and the NRM management module comprises a non-real-time RAN Intelligent Controller.

13. Method for operating a mobile communication network comprising a plurality of network nodes configured to implement network functions for service provisioning to users of the mobile communication network, and a plurality of network resource controllers configured to perform near-real-time control of access network resources used by the plurality of network nodes for service provisioning on a user request basis, the method comprising, in response to detection of an issue affecting the mobile communication network:
retrieving performance data indicative of performance of the mobile communication network;
retrieving configuration data indicative of at least one between a configuration of at least one network node, among the plurality of network nodes, being involved by the issue, and a configuration of at least one network resource controller, among the plurality of network resource controllers, being involved by the issue; and
based on the performance data and configuration data, and on one or more among a type of issue, a type of service, a type of users, available configurations for the plurality of network resource controllers, and available self-organizing network algorithms, determining reconfiguration of at least one between the at least one network node and the at least one network resource controller by enabling an operation of at least one between a self-organizing network module configured to determine optimal configurations of the plurality of network nodes according to working conditions thereof and a network resource model management module configured to manage configurations of the plurality of network resource controllers.

14. One or more non-transitory computer-readable media having computer-executable instructions stored thereon that when executed by a computing device, perform a method for operating a mobile communication network comprising a plurality of network nodes configured to implement network functions for service provisioning to users of the mobile communication network, and a plurality of network resource controllers configured to perform near-real-time control of access network resources used by the plurality of network nodes for service provisioning on a user request basis, the method comprising, in response to detection of an issue affecting the mobile communication network:
retrieving performance data indicative of performance of the mobile communication network;
retrieving configuration data indicative of at least one between a configuration of at least one network node, among the plurality of network nodes, being involved by the issue, and a configuration of at least one network resource controller, among the plurality of network resource controllers, being involved by the issue; and
based on the performance data and configuration data, and on one or more among a type of issue, a type of service, a type of users, available configurations for the plurality of network resource controllers, and available self-organizing network algorithms, determining a reconfiguration of at least one between the at least one network node and the at least one network resource controller by enabling an operation of at least one between a self-organizing network module configured to determine optimal configurations of the plurality of network nodes according to working conditions thereof and a network resource model management module configured to manage configurations of the plurality of network resource controllers.
